(19) United States
(12) Patent Application Publication
(10) Pub. No.: US 2010/0237065 A1
(43) Pub. Date: Sep. 23, 2010

(54) HEATING DEVICE

(75) Inventors: Cheng-Hsien Cho, Taoyuan Hsien (TW); Yin-Yuan Chen, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/725,707

(22) Filed: Mar. 17, 2010

(30) Foreign Application Priority Data
Mar. 18, 2009 (TW) 098108822

(51) Int. Cl. H05B 6/12

(52) U.S. Cl. 219/624

(57) ABSTRACT

A heating device includes a first induction coil, a second induction coil, a control panel, a power supply unit and a controlling unit. The control panel issues an adjusting signal. The power supply unit provides a first power and a second power to the first induction coil and the second induction coil, respectively. The controlling unit generates a control signal to the power supply unit according to the adjusting signal, thereby controlling the first power and the second power. Electrical energy is transmitted to the first induction coil and the second induction coil and the frequency difference between the first power and the second power is greater than 15 kHz or smaller than 1 kHz during a first time interval under control of the controlling unit. No electrical energy is transmitted to one of the first induction coil and the second induction coil during a second time interval under control of the controlling unit.

### FIELD OF THE INVENTION

The present invention relates to a heating device, and more particularly to a heating device for simultaneously heating multiple foodstuff containers.

### BACKGROUND OF THE INVENTION

Nowadays, a variety of cooking utensils such as gas stoves, infrared oven, microwave oven and electric stove are widely used to cook food. Different cooking utensils have their advantages or disadvantages. Depending on the food to be cooked, a desired cooking utensil is selected.

Take an induction cooking stove for example. When a current flows through the induction coil of the induction cooking stove, electromagnetic induction is performed to produce eddy current, thereby heating a foodstuff container. For simultaneously heating multiple foodstuff containers, the heating device needs to have multiple induction coils. By adjusting the electricity quantities to the induction coils, the heating temperatures of respective induction coils are determined.

When multiple induction coils are used to heat foodstuff containers, the induction coils have respective operating frequency values. If the frequency difference between any two induction coils lies within the human hearing range, undesired noise is generated. The user usually feels uncomfortable when hearing the noise. Moreover, since the volume of the noise is varied according to the food type, the food amount, the foodstuff container size and foodstuff container type, the user may mistake a breakdown of the heating device. If the heating device returned to the depot service, unnecessary inspecting cost and time are required.

There is a need of providing an improved heating device so as to obviate the drawbacks encountered from the prior art.

### SUMMARY OF THE INVENTION

It is an object of the present invention to provide a heating device for simultaneously heating multiple foodstuff containers in order to eliminate noise and adjust desired heat quality or heating temperature.

In accordance with an aspect of the present invention, there is provided a heating device for heating at least one foodstuff container. The heating device includes a first induction coil, a second induction coil, a control panel, a power supply unit and a controlling unit. The control panel is operated to issue an adjusting signal. The power supply unit is connected with the first induction coil and the second induction coil for providing a first power and a second power to the first induction coil and the second induction coil, respectively. The controlling unit is connected with the control panel and the power supply unit and generates a control signal to the power supply unit according to the adjusting signal, thereby controlling the first power and the second power of the power supply unit. Electrical energy is transmitted to the first induction coil and the second induction coil and the frequency difference between the first power and the second power is greater than 15 kHz or smaller than 1 kHz during a first time interval under control of the controlling unit. No electrical energy is transmitted to one of the first induction coil and the second induction coil during a second time interval under control of the controlling unit.

In accordance with another aspect of the present invention, there is provided a heating device for heating at least one foodstuff container. The heating device includes a first induction coil, a second induction coil, a control panel, a power supply unit and a controlling unit. The control panel is operated to issue an adjusting signal. The power supply unit is connected with the first induction coil and the second induction coil for providing a first power and a second power to the first induction coil and the second induction coil, respectively. The controlling unit is connected with the control panel and the power supply unit and generates a control signal to the power supply unit according to the adjusting signal, thereby controlling the first power and the second power of the power supply unit. The frequency difference between the first power and the second power is greater than 15 kHz during a first time interval and during a third time interval. The frequency difference between the first power and the second power is smaller than 1 kHz during a second time interval.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a heating device according to a first embodiment of the present invention;

FIG. 2A is a timing waveform diagram schematically illustrating the first frequency and the second frequency processed in the heating device of FIG. 1 according to a first implementing example;

FIG. 2B is a timing waveform diagram schematically illustrating the first frequency and the second frequency processed in the heating device of FIG. 1 according to a second implementing example;

FIG. 2C is a timing waveform diagram schematically illustrating the first frequency and the second frequency processed in the heating device of FIG. 1 according to a third implementing example;

FIG. 2D is a timing waveform diagram schematically illustrating the first frequency and the second frequency processed in the heating device of FIG. 1 according to a fourth implementing example;

FIG. 3A is a timing waveform diagram schematically illustrating the first frequency and the second frequency processed in the heating device of FIG. 1 according to a fifth implementing example; and

FIG. 3B is a timing waveform diagram schematically illustrating the first frequency and the second frequency processed in the heating device of FIG. 1 according to a sixth implementing example.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

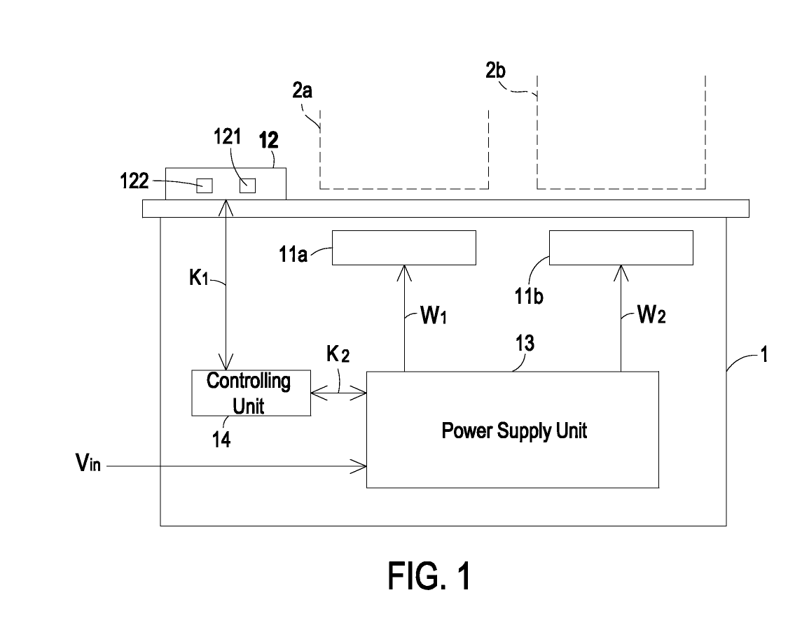

FIG. 1 is a schematic functional block diagram illustrating a heating device according to a first embodiment of the present invention. The heating device 1 comprises a first induction coil 11a, a second induction coil 11b, a control panel 12, a power supply unit 13 and a controlling unit 14. When a current flows through the first induction coil 11a and the second induction coil 11b, electromagnetic induction is performed to produce eddy current, thereby heating a first foodstuff container 2a and a second foodstuff container 2b. The first induction coil 11a and the second induction coil 11b are connected to a first power output terminal and a second power output terminal of the power supply unit 13, respectively.

The control panel 12 is disposed on the outer surface of the heating device 1 and connected to the controlling unit 14. By operating the control panel 12, a corresponding adjusting signal K₁ is transmitted to the controlling unit 14. According to the adjusting signal K₁, the amount of heating energy outputted from the first induction coil 11a and the second induction coil 11b are adjusted. The power supply unit 13 is connected to the first induction coil 11a and the second induction coil 11b for providing a first power signal W₁ and a second power signal W₂ to the first induction coil 11a and the second induction coil 11b, respectively. The controlling unit 14 is connected to the control panel 12 and the power supply unit 13. According to the adjusting signal K₁, the controlling unit 14 issues a control signal K₂ to the power supply unit 13. According to the control signal K₂, the power supply unit 13 provides the first power signal W₁ and the second power signal W₂ to the first induction coil 11a and the second induction coil 11b, respectively. An example of the controlling unit 14 includes but is not limited to a pulse frequency modulation (PFM) controller or a digital signal processor (DSP).

In an embodiment, the power supply unit 13 is an AC-to-AC converting circuit. The electricity quantity outputted from the power supply unit 13 to the first induction coil 11a is in reverse proportion to the magnitude of the first frequency f₁ of the first power signal W₁. Similarly, the electricity quantity outputted from the power supply unit 13 to the second induction coil 11b is in reverse proportion to the magnitude of the second frequency f₂ of the second power signal W₂. By the power supply unit 13, an input AC voltage Vᵢₙ is converted into the first power signal W₁ and the second power signal W₂. As the adjusting signal K₁ is altered, the control signal K₂ is changed. According to the control signal K₂, the first frequency f₁ of the first power signal W₁ and the second frequency f₂ of the second power signal W₂ are adjusted, and thus the electricity quantity outputted from the power supply unit 13 to the first induction coil 11a or the second induction coil 11b is adjusted. In other words, the amount of heating energy outputted from the first induction coil 11a and the second induction coil 11b to respectively heat the first foodstuff container 2a and the second foodstuff container 2b will be adjusted.

In an embodiment, the control panel 12 comprises two operating elements 121 and 122. The operating elements 121 and 122 are button-type operating elements or rotary operating elements. The operating elements 121 and 122 are manipulated by a user in order to adjust the temperature or heat quantity to be applied to the first foodstuff container 2a and the second foodstuff container 2b. By operating the operating elements 121 and 122 to select desired temperature or heat quantity, a corresponding adjusting signal K₁ is transmitted from the control panel 12 to the controlling unit 14. After the adjusting signal K₁ is received, the controlling unit 14 issues a control signal K₂ to the power supply unit 13 by computation. According to the control signal K₂, the first frequency f₁ of the first power signal W₁ and the second frequency f₂ of the second power signal W₂ are determined.

In some embodiments, the first induction coil 11a and the second induction coil 11b are used to heat the first foodstuff container 2a and the second foodstuff container 2b, respectively. In some embodiments, the first induction coil 11a and the second induction coil 11b collectively heat a single foodstuff container (not shown). Hereinafter, the first foodstuff container 2a and the second foodstuff container 2b respectively heated by the first induction coil 11a and the second induction coil 11b will be illustrated.

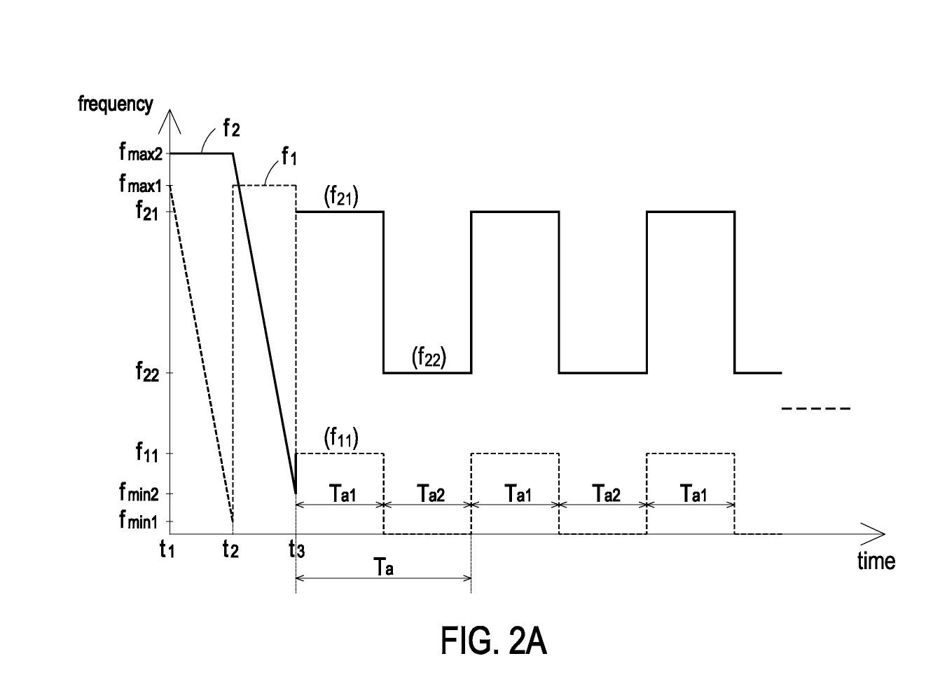

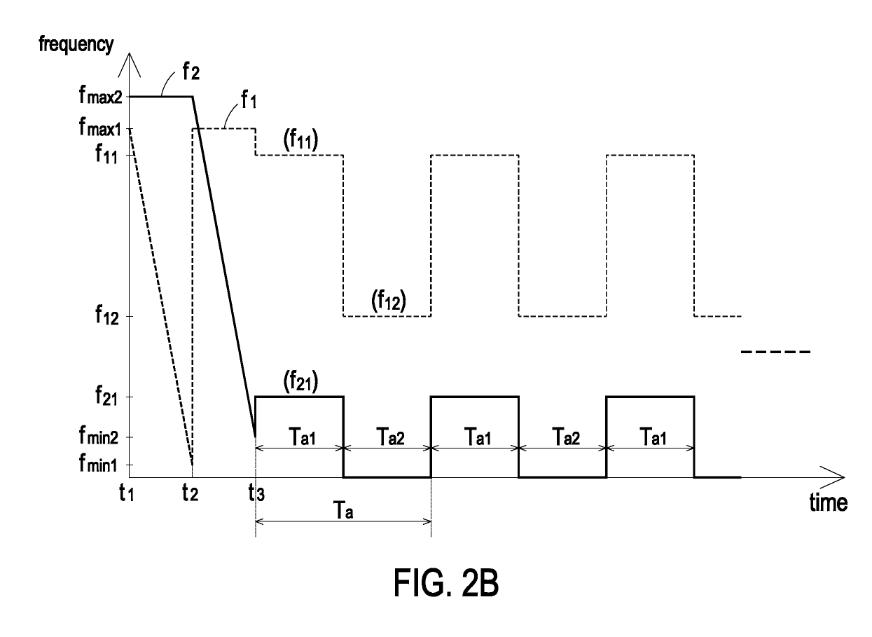

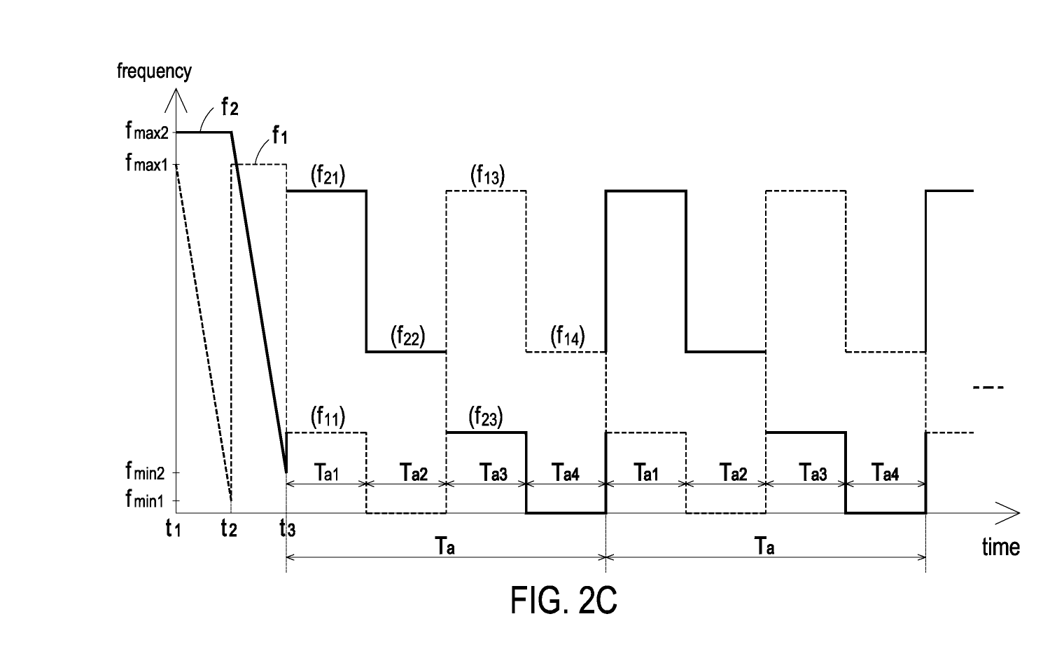

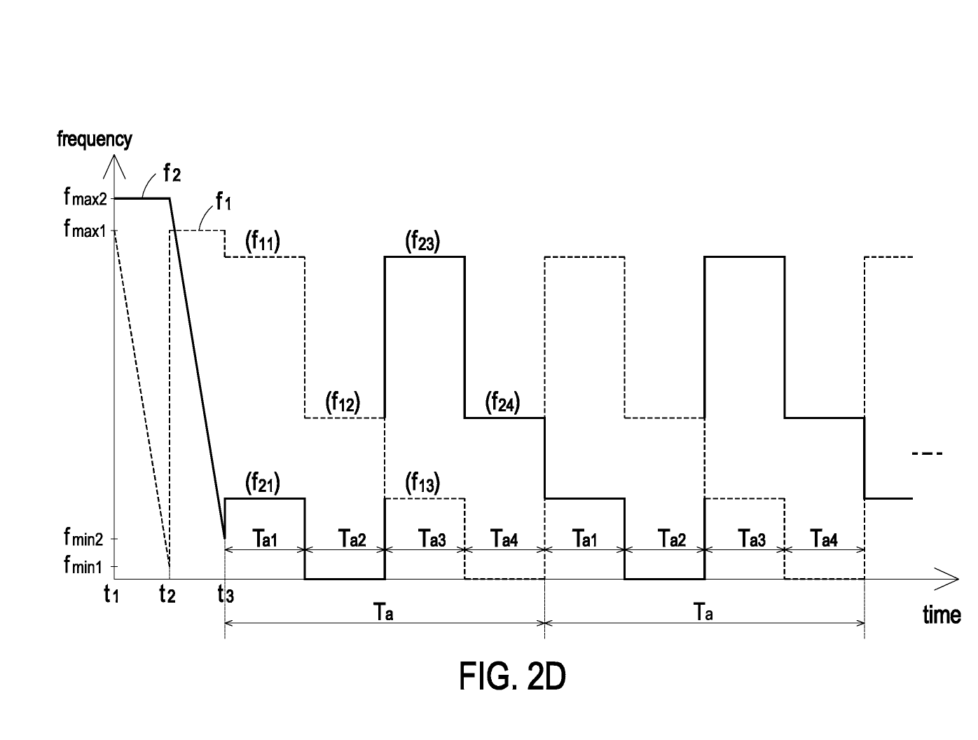

FIG. 2A is a timing waveform diagram schematically illustrating the first frequency and the second frequency processed in the heating device of FIG. 1 according to a first implementing example. Before t=t₁, the heating device 1 is disabled and no electricity is supplied to the first induction coil 11a and the second induction coil 11b. As such, the magnitudes of the first power signal W₁ and the second power signal W₂ are zero, and no heating operations are done by the first induction coil 11a and the second induction coil 11b.

At t=t₁, the heating device 1 is enabled. At t=t₃, the heating device 1 starts the heating operation. In some embodiments, the controlling unit 14 could detect some heating parameters from t=t₁ to t=t₃. The heating parameters include for example a first minimum frequency value fₘᵢₙ₁, a second minimum frequency value fₘᵢₙ₂, a first minimum power value Pₘᵢₙ₁ and a second minimum power value Pₘᵢₙ₂.

From t=t₁ to t=t₂, the second frequency f₂ of the second power signal W₂ is maintained at a second maximum frequency value fₘₐₓ₂ and thus the second minimum power value Pₘᵢₙ₂ is inputted to the second induction coil 11b. Under control of the controlling unit 14, the first frequency f₁ of the first power signal W₁ is gradually decreased from a first maximum frequency value fₘₐₓ₁ to the first minimum frequency value fₘᵢₙ₁. In other words, the power value inputted to the first induction coil 11a is gradually increased from the first minimum power value Pₘᵢₙ₁ to a first maximum power value Pₘₐₓ₁.

From t=t₂ to t=t₃, the first frequency f₁ of the first power signal W₁ is maintained at the first maximum frequency value fₘₐₓ₁ and thus the first minimum power value Pₘᵢₙ₁ is inputted into the first induction coil 11a. Under control of the controlling unit 14, the second frequency f₂ of the second power signal W₂ is gradually decreased from the second maximum frequency value fₘₐₓ₂ to the second minimum frequency value fₘᵢₙ₂. In other words, the power value inputted to the second induction coil 11b is gradually increased from the second minimum power value Pₘᵢₙ₂ to a second maximum power value Pₘₐₓ₂.

In some embodiments, the second power signal W₂ is zero from t=t₁ to t=t₂ such that no power is inputted to the second induction coil 11b; and the first power signal W₁ is zero from t=t₂ to t=t₃ such that no power is inputted to the first induction coil 11a.

At t=t₃, the heating device 1 starts the heating operation. Due to electromagnetic induction, the first foodstuff container 2a and the second foodstuff container 2b are heated by the first induction coil 11a and the second induction coil 11b, respectively. The heating time period includes multiple alternating first time intervals Tₐ₁ and second time intervals Tₐ₂. During the first time interval Tₐ₁, the first frequency f₁ and the second frequency f₂ are both greater than the upper limit of human hearing range; and the difference between the first frequency f₁ and the second frequency f₂ is greater than the upper limit of human hearing range or smaller than the lower limit of human hearing range. In this context, the upper limit of human hearing range is approximately 15 kHz˜25 kHz and the lower limit of human hearing range is approximately 1 kHz.

As shown in FIG. 2A, during the first time interval Tₐ₁, the first frequency f₁ of the first power signal W₁ and the second frequency f₂ of the second power signal W₂ are respectively maintained at the frequency values f₁₁ and f₂₁, wherein f₁₁ is smaller than f₂₁. Since the power values inputted into the first induction coil 11a and the second induction coil 11b are respectively in reverse proportion to f₁₁ and f₂₁, the electrical energy outputted from the power supply unit 13 is mostly transmitted to the first induction coil 11a to heat the first foodstuff container 2a.

Please refer to FIG. 2A again. During the second time interval Tₐ₂, the first power signal W₁ is zero and thus the first foodstuff container 2a is not heated by the first induction coil 11a. During the second time interval Tₐ₂, the second frequency f₂ of the second power signal W₂ is maintained at the frequency value f₂₂, wherein the frequency value f₂₂ is greater than the upper limit of human hearing range. Since the first power signal W₁ is zero, the electrical energy outputted from the power supply unit 13 is totally transmitted to the second induction coil 11b to heat the second foodstuff container 2b.

Since the difference between the first frequency f₁ and the second frequency f₂ beyond the human hearing range during the first time interval Tₐ₁ is effective to eliminate the noise, there are still some drawbacks. For example, the electricity quantities outputted from the power supply unit 13 to the first induction coil 11a and the second induction coil 11b fail to be respectively controlled. In other words, either the first frequency f₁ or the second frequency f₂ is usable during the first time interval Tₐ₁. As such, the temperature or heat quantity to be applied to either the first foodstuff container 2a or the second foodstuff container 2b is adjustable.

Please refer to FIG. 2A again. During the first time interval Tₐ₁, the first frequency f₁ of the first power signal W₁ is adjusted to the frequency value f₁₁ according to the adjusting signal K₁ under control of the controlling unit 14. As such, desired heat quantity to be applied to the first foodstuff container 2a is adjusted. On the other hand, since the frequency value f₂₁ needs to meet the frequency difference requirement (i.e. greater than the upper limit of human hearing range or smaller than the lower limit of human hearing range), the frequency value f₂₁ fails to accurately reflect the desired heat quantity.

During the second time interval Tₐ₂, the first power signal W₁ is zero and the second frequency f₂ of the second power signal W₂ is maintained at the frequency values f₂₂. Since the frequency values f₂₂ is greater than the upper limit of human hearing range, no hearable noise is generated. Under this circumstance, the second frequency f₂ of the second power signal W₂ is adjusted to the frequency values f₂₂ according to the adjusting signal K₁ under control of the controlling unit 14. As such, desired heat quantity to be applied to the second foodstuff container 2b is adjusted.

In this embodiment, a first average heat quantity P₁ offered from the first induction coil 11a to the first foodstuff container 2a and a second average heat quantity P₂ offered from the second induction coil 11b to the second foodstuff container 2b could be deduced according to the following formulas:

$$\begin{matrix}{P}_{1} = {P}_{11} ( {f}_{11} ) \cdot \frac{{T}_{a 1}}{{T}_{a 1} + {T}_{a 2}} \\ = {P}_{11} ( {f}_{11} ) \cdot \frac{{T}_{a 1}}{{T}_{a }} \\ {P}_{2} = {P}_{21} ( {f}_{21} ) \cdot \frac{{T}_{a 1}}{{T}_{a 1} + {T}_{a 2}} + {P}_{22} ( {f}_{22} ) \cdot \frac{{T}_{a 2}}{{T}_{a 1} + {T}_{a 2}} \\ = {P}_{21} ( {f}_{21} ) \cdot \frac{{T}_{a 1}}{{T}_{a }} + {P}_{22} ( {f}_{22} ) \cdot \frac{{T}_{a 2}}{{T}_{a }}\end{matrix}$$

where,
P₁₁ is a function of the frequency values f₁₁ and denotes the heat quantity offered from the first induction coil 11a to the first foodstuff container 2a during the first time interval Tₐ₁,
P₂₁ is a function of the frequency values f₂₁ and denotes the heat quantity offered from the second induction coil 11b to the second foodstuff container 2b during the first time interval Tₐ₁,
P₂₂ is a function of the frequency values f₂₂ and denotes the heat quantity offered from the second induction coil 11b to the second foodstuff container 2b during the second time interval Tₐ₂; and
Tₐ denotes a heating cycle, which is equal to the sum of the first time interval Tₐ₁ and the second time interval Tₐ₂.

From the above formulae, it is found that a desired first average heat quantity P₁ is obtained by adjusting the duration of the first time interval Tₐ₁. Similarly, a desired second average heat quantity P₂ is obtained by adjusting the duration of the first time interval Tₐ₁ or the second time interval Tₐ₂. In particular, by adjusting the frequency values f₂₂, the duration of the first time interval Tₐ₁ or the second time interval Tₐ₂, a desired second average heat quantity P₂ is obtained.

The first maximum power value Pₘₐₓ₁ (or the first minimum frequency value fₘᵢₙ₁) and the first minimum power value Pₘᵢₙ₁ (or the first maximum frequency value fₘₐₓ₁) of the first induction coil 11a are dependent on the size and material of the first foodstuff container 2a. In addition, the second maximum power value Pₘₐₓ₂ (or the second minimum frequency value fₘᵢₙ₂) and the second minimum power value Pₘᵢₙ₂ (or the second maximum frequency value fₘₐₓ₂) of the second induction coil 11b is dependent on the size and material of the second foodstuff container 2b. That is, the first minimum frequency value fₘᵢₙ₁, the second minimum frequency value fₘᵢₙ₂, the first minimum power value Pₘᵢₙ₁ and the second minimum power value Pₘᵢₙ₂ are not constant.

The induction heat quantity of the first induction coil 11a involves the first minimum frequency value fₘᵢₙ₁ and the first minimum power value Pₘᵢₙ₁ (not shown in the formula of the first average heat quantity P₁). The induction heat quantity of the second induction coil 11b involves the second minimum frequency value fₘᵢₙ₂ and the second minimum power value Pₘᵢₙ₂ (not shown in the formula of the second average heat quantity P₂). The control signal K₂ is calculated by the controlling unit 14 according to the adjusting signal K₁, the first minimum frequency value fₘᵢₙ₁, the first minimum power value Pₘᵢₙ₁, the second minimum frequency value fₘᵢₙ₂ and the second minimum power value Pₘᵢₙ₂. If these values fₘᵢₙ₁, Pₘᵢₙ₁, fₘᵢₙ₂ and Pₘᵢₙ₂ are constant, the error of the control signal K₂ is too large and thus the heating device fails to achieve the desired heating temperature or heat quantity.

Before the heating operation is performed, the controlling unit 14 would detect the accurate values fₘᵢₙ₁, Pₘᵢₙ₁, fₘᵢₙ₂ and Pₘᵢₙ₂. In addition, the first time interval Tₐ₁, the second time interval Tₐ₂, the heat quantity P₁₁, P₂₁ and P₂₂ are determined by the controlling unit 14 according to the accurate values fₘᵢₙ₁, Pₘᵢₙ₁, fₘᵢₙ₂ and Pₘᵢₙ₂. As a consequence, the control signal K₂ is accurately generated and thus the heating device fails to achieve the desired heating temperature or heat quantity.

FIG. 2B is a timing waveform diagram schematically illustrating the first frequency and the second frequency processed in the heating device of FIG. 1 according to a second implementing example. In comparison with FIG. 2A, during the first time interval Tₐ₁, the second frequency f₂ of the second power signal W₂ is adjusted to the frequency values f₂₁ according to the adjusting signal K₁ under control of the controlling unit 14. As such, desired heat quantity or temperature to be applied to the second foodstuff container 2b is adjusted. In addition, the difference between the frequency value f₁₁ and the frequency value f₂₁ is greater than the upper limit of human hearing range or smaller than the lower limit of human hearing range. During the second time interval Tₐ₂, the second power signal W₂ is zero and thus the second foodstuff container 2b is not heated by the second induction coil 11b. The frequency value f₁₂ is greater than the upper limit of human hearing range. Since the second power signal W₂ is zero, the electrical energy outputted from the power supply unit 13 is totally transmitted to the first induction coil 11a to heat the first foodstuff container 2a.

In this embodiment, a first average heat quantity P₁ offered from the first induction coil 11a to the first foodstuff container 2a and a second average heat quantity P₂ offered from the second induction coil 11b to the second foodstuff container 2b could be deduced according to the following formulas:

$$\begin{matrix}{P}_{1} = {P}_{11} ( {f}_{11} ) \cdot \frac{{T}_{a 1}}{{T}_{a }} + {P}_{12} ( {f}_{12} ) \cdot \frac{{T}_{a 2}}{{T}_{a }} \\ {P}_{2} = {P}_{21} ( {f}_{21} ) \cdot \frac{{T}_{a 1}}{{T}_{a }}\end{matrix}$$

where,
P₁₁ is a function of the frequency values f₁₁ and denotes the heat quantity offered from the first induction coil 11a to the first foodstuff container 2a during the first time interval Tₐ₁;
P₁₂ is a function of the frequency values f₁₂ and denotes the heat quantity offered from the first induction coil 11a to the first foodstuff container 2a during the second time interval Tₐ₂;
P₂₁ is a function of the frequency values f₂₁ and denotes the heat quantity offered from the second induction coil 11b to the second foodstuff container 2b during the first time interval Tₐ₁; and
Tₐ denotes a heating cycle, which is equal to the sum of the first time interval Tₐ₁ and the second time interval Tₐ₂.

FIG. 2C is a timing waveform diagram schematically illustrating the first frequency and the second frequency processed in the heating device of FIG. 1 according to a third implementing example. In comparison with FIG. 2A, the heating cycle includes a first time interval Tₐ₁, a second time interval Tₐ₂, a third time interval Tₐ₃ and a fourth time interval Tₐ₄. During the first time interval Tₐ₁, the heat quantity to be applied to the first foodstuff container 2a is dependent on the frequency value f₁₁. The difference between the frequency value f₁₁ and the frequency value f₂₁ is greater than the upper limit of human hearing range or smaller than the lower limit of human hearing range. During the second time interval Tₐ₂, the first power signal W₁ is zero and the heat quantity to be applied to the second foodstuff container 2b is dependent on the frequency values f₂₂. The frequency value f₂₂ is greater than the upper limit of human hearing range. During the third time interval Tₐ₃, the heat quantity to be applied to the second foodstuff container 2b is dependent on the frequency value f₂₃. The difference between the frequency value f₁₃ and the frequency value f₂₃ is greater than the upper limit of human hearing range or smaller than the lower limit of human hearing range. During the forth time interval Tₐ₄, the second power signal W₂ is zero and the heat quantity to be applied to the first foodstuff container 2a is dependent on the frequency values f₁₄. The frequency value f₁₄ is greater than the upper limit of human hearing range.

FIG. 2D is a timing waveform diagram schematically illustrating the first frequency and the second frequency processed in the heating device of FIG. 1 according to a fourth implementing example. The heating cycle includes a first time interval Tₐ₁, a second time interval Tₐ₂, a third time interval Tₐ₃ and a fourth time interval Tₐ₄. During the first time interval Tₐ₁, the heat quantity to be applied to second foodstuff container 2b is dependent on the frequency value f₂₁. The difference between the frequency value f₁₁ and the frequency value f₂₁ is greater than the upper limit of human hearing range or smaller than the lower limit of human hearing range. During the second time interval Tₐ₂, the second power signal W₂ is zero and the heat quantity to be applied to the first foodstuff container 2a is dependent on the frequency value f₁₂. The frequency value f₁₂ is greater than the upper limit of human hearing range. During the third time interval Tₐ₃, the heat quantity to be applied to the first foodstuff container 2a is dependent on the frequency value f₁₃. The difference between the frequency value f₁₃ and the frequency value f₂₃ is greater than the upper limit of human hearing range or smaller than the lower limit of human hearing range. During the forth time interval Tₐ₄, the first power signal W₁ is zero and the heat quantity to be applied to the second foodstuff container 2b is dependent on the frequency value f₂₄. The frequency value f₂₄ is greater than the upper limit of human hearing range.

In FIGS. 2C and 2D, the heat quantity or heating temperature of the first foodstuff container 2a or the second foodstuff container 2b could be controlled by the controlling unit 14 according to various heating parameters, including the time interval Tₐ₁, Tₐ₂, Tₐ₃, Tₐ₄ and the frequency values f₁₁, f₂₁, f₁₂, f₂₂, f₁₃, f₂₃, f₁₄ and/or f₂₄.

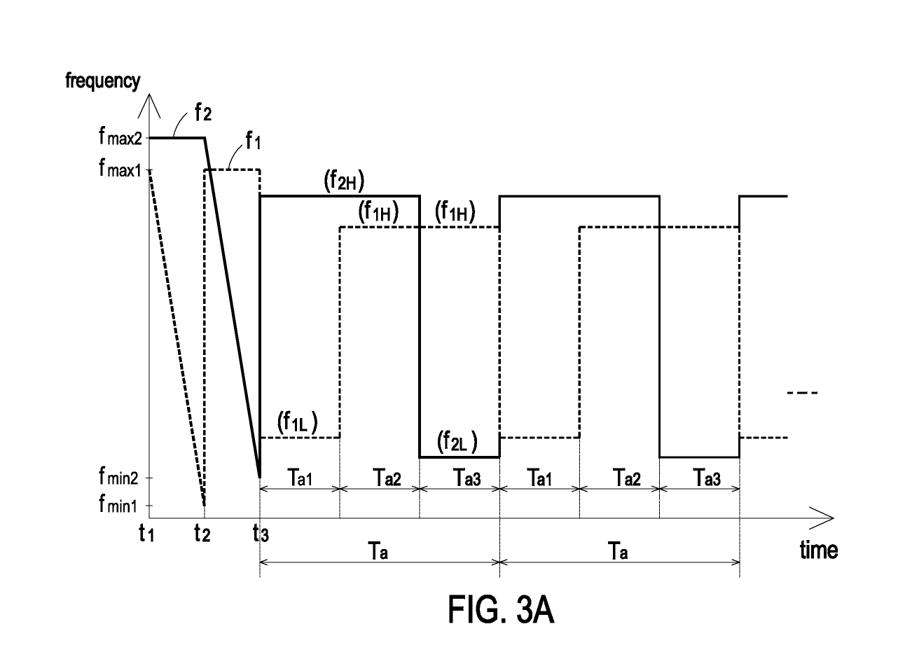

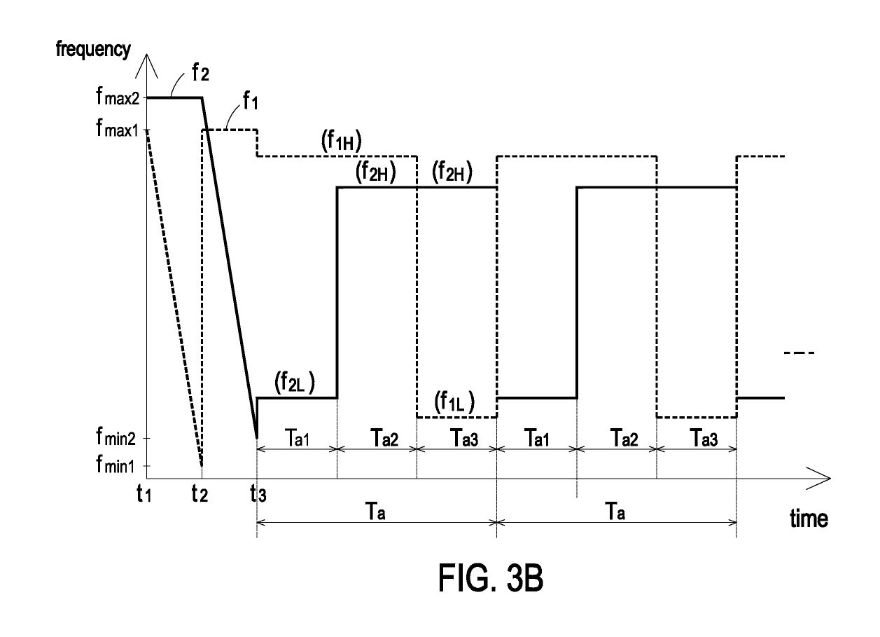

FIG. 3A is a timing waveform diagram schematically illustrating the first frequency and the second frequency processed in the heating device of FIG. 1 according to a fifth implementing example.

At t=t₁, the heating device 1 is enabled. At t=t₃, the heating device 1 starts the heating operation. In some embodiments, the controlling unit 14 could detect some heating parameters from t=t₁ to t=t₃. The heating parameters include for example a first minimum frequency value fₘᵢₙ₁, a second minimum frequency value fₘᵢₙ₂, a first minimum power value Pₘᵢₙ₁ and a second minimum power value Pₘᵢₙ₂. The heating time period Tₐ includes multiple alternating first time intervals Tₐ₁, second time intervals Tₐ₂ and third time interval Tₐ₃. In other words, a heating cycle Tₐ includes a first time interval Tₐ₁, a second time interval Tₐ₂ and a third time interval Tₐ₃. For each heating time period Tₐ, the first frequency f₁ and the second frequency f₂ are both greater than the upper limit of human hearing range. During the first time intervals Tₐ₁ and the third time interval Tₐ₃, the difference between the first frequency f₁ and the second frequency f₂ is greater than the upper limit of human hearing range. During the second time interval Tₐ₂, the difference between the first frequency f₁ and the second frequency f₂ is smaller than the lower limit of human hearing range. During the second time interval Tₐ₂, the first frequency f₁ and the second frequency f₂ are maintained at the high frequency values f_{1H} and f_{2H}, respectively. During the first time interval Tₐ₁, the first frequency f₁ and the second frequency f₂ are maintained at the low frequency value f_{1L} and the high frequency value f_{2H}, respectively. During the third time interval Tₐ₃, the first frequency f₁ and the second frequency f₂ are maintained at the high frequency value f_{1H} and the low frequency value f_{2L}, respectively. In a case that the first frequency f₁ is maintained at the low frequency value f_{1L} during the first time interval Tₐ₁, the first frequency f₁ is maintained at the high frequency value f_{1H} during the third time interval Tₐ₃. In a case that the first frequency f₁ is maintained at the high frequency value f_{1H} during the first time interval Tₐ₁, the first frequency f₁ is maintained at the low frequency value f_{1L} during the third time interval Tₐ₃. Similarly, in a case that the second frequency f₂ is maintained at the low frequency value f_{2L} during the first time interval Tₐ₁, the second frequency f₂ is maintained at the high frequency value f_{2H} during the third time interval Tₐ₃. In a case that the second frequency f₂ is maintained at the high frequency value f_{2H} during the first time interval Tₐ₁, the second frequency f₂ is maintained at the low frequency value f_{2L} during the third time interval Tₐ₃.

Please refer to FIG. 3A again. The first frequency f₁ and the second frequency f₂ are respectively maintained at the low frequency value f_{1L} and the high frequency value f_{2H} during the first time interval Tₐ₁, the first frequency f₁ and the second frequency f₂ are respectively maintained at the high frequency values f_{1H} and f_{2H} during the second time interval Tₐ₁; and the first frequency f₁ and the second frequency f₂ are respectively maintained at the high frequency value f_{1H} and the low frequency value f_{2L} during the third time interval Tₐ₃.

In this embodiment, a first average heat quantity P₁ offered from the first induction coil 11a to the first foodstuff container 2a and a second average heat quantity P₂ offered from the second induction coil 11b to the second foodstuff container 2b could be deduced according to the following formulas:

$${P}_{1} = {P}_{1 L} ( {f}_{1 L} ) \cdot \frac{{T}_{a 1}}{{T}_{a }} + {P}_{1 H} ( {f}_{1 H} ) \cdot \frac{{T}_{a 2} + {T}_{a 3}}{{T}_{a }}$$

$${P}_{2} = {P}_{2 L} ( {f}_{2 L} ) \cdot \frac{{T}_{a 3}}{{T}_{a }} + {P}_{2 H} ( {f}_{2 H} ) \cdot \frac{{T}_{a 1} + {T}_{a 2}}{{T}_{a }}$$

where,
P_{1L} is a function of the low frequency values f_{1L} and denotes the heat quantity offered from the first induction coil 11a to the first foodstuff container 2a;
P_{1H} is a function of the high frequency values f_{1H} and denotes the heat quantity offered from the first induction coil 11a to the first foodstuff container 2a;
P_{2L} is a function of the low frequency values f_{2L} and denotes the heat quantity offered from the second induction coil 11b to the second foodstuff container 2b; and
P_{2H} is a function of the high frequency values f_{2H} and denotes the heat quantity offered from the second induction coil 11b to the second foodstuff container 2b.

Please refer to FIG. 3A again. During the first time interval Tₐ₁, the first frequency f₁ of the first power signal W₁ is adjusted to the low frequency value f_{1L} according to the adjusting signal K₁ under control of the controlling unit 14. As such, desired heat quantity to be applied to the first foodstuff container 2a is adjusted. The second frequency f₂ is adjusted to the high frequency value f_{2H} such that the difference between the low frequency value f_{1L} and the high frequency value f_{2H} is greater than the upper limit of human hearing range or smaller than the lower limit of human hearing range. During the third time interval Tₐ₃, the second frequency f₂ of the second power signal W₂ is adjusted to the low frequency value f_{2L} according to the adjusting signal K₁ under control of the controlling unit 14. As such, desired heat quantity to be applied to the second foodstuff container 2b is adjusted. The first frequency f₁ is adjusted to the high frequency value f_{1H} such that the difference between the high frequency value f_{1H} and the low frequency value f_{2L} is greater than the upper limit of human hearing range or smaller than the lower limit of human hearing range.

Under control of the controlling unit 14, a desired first average heat quantity P₁ and a desired second average heat quantity P₂ are obtained by adjusting the first frequency f₁ and the second frequency f₂ to the low frequency value f_{1L} and f_{2L} during the first time interval Tₐ₁ and the third time interval Tₐ₃. In some embodiments, a desired first average heat quantity P₁ and a desired second average heat quantity P₂ are obtained by adjusting the first time interval Tₐ₁, the second time interval Tₐ₂ and the third time interval Tₐ₃.

FIG. 3B is a timing waveform diagram schematically illustrating the first frequency and the second frequency processed in the heating device of FIG. 1 according to a sixth implementing example. The first frequency f₁ and the second frequency f₂ are respectively maintained at the high frequency value f_{1H} and the low frequency value f_{2L} during the first time interval Tₐ₁; the first frequency f₁ and the second frequency f₂ are respectively maintained at the high frequency values f_{1H} and f_{2H} during the second time interval Tₐ₂; and the first frequency f₁ and the second frequency f₂ are respectively maintained at the low frequency value f_{1L} and the high frequency value f_{2H} during the third time interval Tₐ₃.

In this embodiment, a first average heat quantity P₁ offered from the first induction coil 11a to the first foodstuff container 2a and a second average heat quantity P₂ offered from the second induction coil 11b to the second foodstuff container 2b could be deduced according to the following formulas:

$${P}_{1} = {P}_{1 L} ( {f}_{1 L} ) \cdot \frac{{T}_{a 3}}{{T}_{a }} + {P}_{1 H} ( {f}_{1 H} ) \cdot \frac{{T}_{a 1} + {T}_{a 2}}{{T}_{a }}$$

$${P}_{2} = {P}_{2 L} ( {f}_{2 L} ) \cdot \frac{{T}_{a 1}}{{T}_{a }} + {P}_{2 H} ( {f}_{2 H} ) \cdot \frac{{T}_{a 2} + {T}_{a 3}}{{T}_{a }}$$

During the first time interval Tₐ₁, the second frequency f₂ of the second power signal W₂ is adjusted to the low frequency value f_{2L} according to the adjusting signal K₁ under control of the controlling unit 14. As such, desired heat quantity to be applied to the second foodstuff container 2b is adjusted. The first frequency f₁ is adjusted to the high frequency value f_{1H} such that the difference between the high frequency value f_{1H} and the low frequency value f_{2L} is greater than the upper limit of human hearing range or smaller than the lower limit of human hearing range. During the third time interval Tₐ₃, the first frequency f₁ of the first power signal W₁ is adjusted to the low frequency value f_{1L} according to the adjusting signal K₁ under control of the controlling unit 14. As such, desired heat quantity to be applied to the first foodstuff container 2a is adjusted. The second frequency f₂ is adjusted to the high frequency value f_{2H} such that the difference between the low frequency value f_{1L} and the high frequency value f_{2H} is greater than the upper limit of human hearing range or smaller than the lower limit of human hearing range.

Similarly, under control of the controlling unit 14, a desired first average heat quantity P₁ and a desired second average heat quantity P₂ are obtained by adjusting the first frequency f₁ and the second frequency f₂ to the low frequency value f_{1L} and f_{2L} during the first time interval Tₐ₁ and the third time interval Tₐ₃. In some embodiments, a desired first average heat quantity P₁ and a desired second average heat quantity P₂ are obtained by adjusting the first time interval Tₐ₁, the second time interval Tₐ₂ and the third time interval Tₐ₃.

In some embodiments, the frequency values f_{1H}, f_{2H}, f_{1L} and f_{2L} are respectively maintained at the first maximum frequency value fₘₐₓ₁, the second maximum frequency value fₘₐₓ₂, the first minimum frequency value fₘᵢₙ₁ and the second minimum frequency value fₘᵢₙ₂ under control of the controlling unit 14. By adjusting the durations of the first time interval Tₐ₁, the second time interval Tₐ₂, and the third time interval Tₐ₃, a desired heat quantity offered from the first induction coil 11a to the first foodstuff container 2a and a desired heat quantity offered from the second induction coil 11b to the second foodstuff container 2b are achieved. Since the frequency values f_{1H}, f_{2H}, f_{1L} and f_{2L} are respectively maintained at fₘₐₓ₁, fₘₐₓ₂, fₘᵢₙ₁ and fₘᵢₙ₂, after the foodstuff containers 2a and 2b reach the set temperatures, the first time interval Tₐ₁, the second time interval Tₐ₂ or the third time interval Tₐ₃ could be optionally adjusted to zero according to the heat loss under control of the controlling unit 14.

In the above embodiments, the first time interval Tₐ₁, the second time interval Tₐ₂, the third time interval Tₐ₃ and the fourth time interval Tₐ₄ could be arranged at any order.

From the above description, the heating cycle of the heating device 1 includes at least a first time interval Tₐ₁ and a second time interval Tₐ₂. During the first time interval Tₐ₁, the first frequency f₁ and the second frequency f₂ are both greater than the upper limit of human hearing range; and the difference between the first frequency f₁ and the second frequency f₂ is greater than the upper limit of human hearing range or smaller than the lower limit of human hearing range. As a consequence, no undesirable noise is generated. During the second time interval Tₐ₂, the first induction coil 11a is disabled but the second frequency f₂ is maintained at a level greater than the upper limit of human hearing range. In such manner, the heat quantity or the heating temperature of the first induction coil 11a and the second induction coil 11b could be accurately controlled.

Before the heating operation is performed, the controlling unit 14 of the heating device 1 detects some heating parameters such as the first minimum frequency value fₘᵢₙ₁, the second minimum frequency value fₘᵢₙ₂, the first minimum power value Pₘᵢₙ₁ and the second minimum power value Pₘᵢₙ₂. Since the first time interval Tₐ₁, the second time interval Tₐ₂, the third time interval Tₐ₃, the fourth time interval Tₐ₄, the first average heat quantity P₁ and the second average heat quantity P₂ are calculated according to the heating parameters, the control signal K₂ could accurately reflect the desired heat quantity. In other word, the heat quantity or the heating temperature could be accurately controlled by the heating device 1 of the present invention. Since the first induction coil 11a and the second induction coil 11b are simultaneously heated during at least one time interval, the heating period will be shortened.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A heating device for heating at least one foodstuff container, said heating device comprising:
a first induction coil;
a second induction coil;
a control panel operated to issue an adjusting signal;
a power supply unit connected with said first induction coil and said second induction coil for providing a first power and a second power to said first induction coil and said second induction coil, respectively;
a controlling unit connected with said control panel and said power supply unit and generating a control signal to said power supply unit according to said adjusting signal, thereby controlling said first power and said second power of said power supply unit,
wherein electrical energy is transmitted to said first induction coil and said second induction coil and the frequency difference between said first power and said second power is greater than 15 kHz or smaller than 1 kHz during a first time interval under control of said controlling unit, and no electrical energy is transmitted to one of said first induction coil and said second induction coil during a second time interval under control of said controlling unit.

2. The heating device according to claim 1 wherein said at least one foodstuff container includes a first foodstuff container and a second foodstuff container, which are heated by said first induction coil and said second induction coil, respectively.

3. The heating device according to claim 1 wherein said controlling unit is a pulse frequency modulation controller or a digital signal processor.

4. The heating device according to claim 1 wherein a first frequency of said first power and a second frequency of said second power are adjusted according to said control signal.

5. The heating device according to claim 4 wherein before said first time interval and said second time interval, said controlling unit detects at least a heating parameter.

6. The heating device according to claim 5 wherein said heating parameter includes a first minimum frequency value, a second minimum frequency value, a first minimum power value and a second minimum power value.

7. The heating device according to claim 6 wherein before said first time interval and said second time interval, said first frequency is gradually decreased from a first maximum frequency value to said first minimum frequency value under control of said controlling unit, thereby detecting said first minimum power value corresponding to said first maximum frequency value and a first maximum power value corresponding to said first minimum frequency value.

8. The heating device according to claim 7 wherein said second power is zero under control of said controlling unit before said first time interval and said second time interval.

9. The heating device according to claim 6 wherein before said first time interval and said second time interval, said second frequency is gradually decreased from a second maximum frequency value to said second minimum frequency value under control of said controlling unit, thereby detecting said second minimum power value corresponding to said second maximum frequency value and a second maximum power value corresponding to said second minimum frequency value.

10. The heating device according to claim 9 wherein said first power is zero under control of said controlling unit before said first time interval and said second time interval.

11. The heating device according to claim 4 wherein during said first time interval, the frequency difference between said first frequency and said second frequency is ranged from 15 kHz to 25 kHz, and the frequency values of said first frequency and said second frequency are greater than 15 kHz.

12. The heating device according to claim 4 wherein during said second time interval, said first power is zero and the frequency value of said second frequency is greater than 15 kHz.

13. The heating device according to claim 4 further comprising a third time interval and a fourth time interval, and wherein each duration of said first time interval, said second time interval, said third time interval and said fourth time interval is adjusted by said control unit.

14. A heating device for heating at least one foodstuff container, said heating device comprising:
a first induction coil;
a second induction coil;
a control panel operated to issue an adjusting signal;
a power supply unit connected with said first induction coil and said second induction coil for providing a first power and a second power to said first induction coil and said second induction coil, respectively; and
a controlling unit connected with said control panel and said power supply unit and generating a control signal to said power supply unit according to said adjusting signal, thereby controlling said first power and said second power of said power supply unit;
wherein the frequency difference between said first power and said second power is greater than 15 kHz during a first time interval and during a third time interval, and the frequency difference between said first power and said second power is smaller than 1 kHz during a second time interval.

15. The heating device according to claim 14 wherein a first frequency of said first power and a second frequency of said second power are adjusted according to said control signal.

16. The heating device according to claim 15 wherein before said first time interval, said second time interval and said third time interval, said controlling unit detects at least a heating parameter.

17. The heating device according to claim 16 wherein said heating parameter includes a first minimum frequency value, a second minimum frequency value, a first minimum power value and a second minimum power value; and wherein said first minimum frequency value is corresponding to a first maximum power value, said second minimum frequency value is corresponding to a second maximum power value, said first minimum power value is corresponding to a first maximum frequency value and said second minimum power value is corresponding to a second maximum frequency value.

18. The heating device according to claim 17 wherein before said first time interval, said second time interval and said third time interval, said first frequency is gradually decreased from said first maximum frequency value to said first minimum frequency value under control of said controlling unit, thereby detecting said first minimum power value corresponding to said first maximum frequency value and said first maximum power value corresponding to said first minimum frequency value.

19. The heating device according to claim 18 wherein said second power is zero under control of said controlling unit before said first time interval, said second time interval and said third time interval.

20. The heating device according to claim 17 wherein before said first time interval, said second time interval and said third time interval, said second frequency is gradually decreased from said second maximum frequency value to said second minimum frequency value under control of said controlling unit, thereby detecting said second minimum power value corresponding to said second maximum frequency value and said second maximum power value corresponding to said second minimum frequency value.

21. The heating device according to claim 20 wherein said first power is zero under control of said controlling unit before said first time interval, said second time interval and said third time interval.

22. The heating device according to claim 17 wherein said first frequency and said second frequency are respectively maintained at a first high frequency value and a second high frequency value during said second time interval; and said first frequency and said second frequency are respectively maintained at a first low frequency value and a second low frequency value during one of said first time interval and said third time interval.

23. The heating device according to claim 22 wherein said first frequency and said second frequency are respectively maintained at said first low frequency value and said second high frequency value during said first time interval; and said first frequency and said second frequency are respectively maintained at said first high frequency value and said second low frequency value during said third time interval.

24. The heating device according to claim 22 wherein said first frequency and said second frequency are respectively maintained at said first high frequency value and said second low frequency value during said first time interval; and said first frequency and said second frequency are respectively maintained at said first low frequency value and said second low frequency value during said third time interval.

25. The heating device according to claim 22 wherein said first low frequency value and said second low frequency value are respectively predetermined as said first minimum frequency value and said second minimum frequency value; said first high frequency value and said second high frequency value are respectively predetermined as said first maximum frequency value and said second maximum frequency value; and each duration of said first time interval, said second time interval and said third time interval is adjusted by said control unit.

26. The heating device according to claim 15 wherein during said first time interval and said third time interval, the frequency difference between said first frequency and said second frequency is ranged from 15 kHz to 25 kHz, and the frequency values of said first frequency and said second frequency are greater than 15 kHz.
